(19) United States
(12) Patent Application Publication
(10) Pub. No.: US 2015/0124050 A1
(43) Pub. Date: May 7, 2015

(54) METHODS AND APPARATUS FOR ENHANCED REALITY MESSAGING

(71) Applicant: Robert Schinker, Commerce Township, MI (US)

(72) Inventor: Robert Schinker, Commerce Township, MI (US)

(21) Appl. No.: 14/071,822

(22) Filed: Nov. 5, 2013

(51) Int. Cl. G03H 1/00; H04N 5/232

(52) U.S. Cl. CPC G03H 1/0005; H04N 5/23203; G03H 2001/005
USPC 348/40

(57) ABSTRACT

A method for delivering an enhanced reality message includes recording a holographic image displayed on a matte surface with the built in camera of a mobile electronic device or web-cam. The holographic image is pre-calibrated to the size of the matte surface to create a “life size” image when projected thereonto. The images are accessed via a downloadable web-based application stored on the mobile device. When the recording is concluded it can be shared via e-mail or social media directly from the software.

### CROSS REFERENCE TO RELATED APPLICATION

This application is related to copending U.S. patent application Ser. No. 13/709,158, filed Dec. 10, 2012, the disclosure of which is hereby incorporated by reference in its entirety including the drawing.

### BACKGROUND OF THE INVENTION

1. Field of the Invention

This invention relates generally to methods and apparatus for sending and receiving messages and, more particularly to methods and apparatus particularly suitable for sending and receiving enhanced or augmented life sized augmented reality audio-visual messages through a mobile device.

2. Prior Art

In the above-referred to copending application there is disclosed an apparatus and method for sending of holographic picture postcards. According to that invention, internet-connected cell phones, cameras, and computers, and similar electronic devices are used to send an audio-visual “post card” message to a recipient. While the invention defined thereon is efficacious, the “post card” is still a “miniaturized” message that is difficult to share with friends, etc. The present invention enhances the aforementioned system by providing a social media friendly system for transmitting enlarged holographic-based messages through a mobile device.

### SUMMARY OF THE INVENTION

In a first aspect of the present invention, there is provided an enhanced internet through a downloadable app message system. The message system hereof is based on the use of a mobile device which is used to access via the internet, a library of holographic images which are displayable on a suitable marker.

The marker is preferably a matte surface or pad which is used to download or project a holographic image thereon.

The software associated with the app detects the surface and is configured to detect changes in the field of view of the camera associated with the image and superimposes an image of the hologram on the marker. The software positions the hologram relative to the marker.

The hologram, also, stays constant in size relative to the marker as a consequence of being pre-calibrated before being placed in the library.

The recording is done directly on the mobile device and creates a multimedia stream representing an enhanced or augmented reality message.

The recording of the enhanced or augmented reality multimedia stream, once finished, can then be shared via e-mail or social media directly from the app that is used to view, and download the hologram.

As noted, the library of holograms is web-based and is accessed via an app stored on the suitable device, e.g. computer, smartphone, tablet, pad and the like. Once accessed the selected image is downloaded or projected onto the surface.

When viewed, a 2D video with a transparent marker is maybe oriented in a 3D environment approximately perpendicular to the marker to create the illusion that a person is standing on top of the marker.

The present system and method contemplates the inclusion an auxiliary image of the environment surrounding the marker.

Additional features of the present invention are described in the detailed description, the accompanying drawings, or both.

The foregoing summary, as well as the following detailed description of certain embodiments of the present invention, will be better understood when read in conjunction with the appended drawings.

### BRIEF DESCRIPTION OF THE DRAWINGS

FIG. 1 is a representation of an environment for producing the recording hereof.

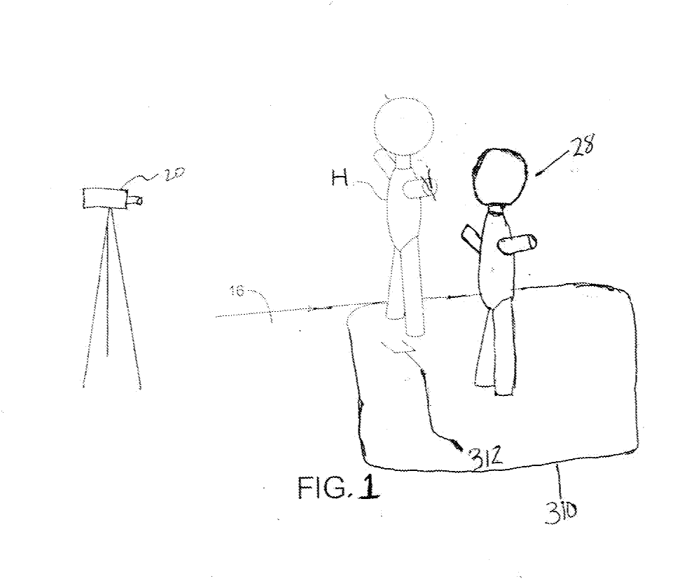

FIG. 2 is a flowchart showing a method useful in conjunction with the present invention.

### DETAILED DESCRIPTION OF THE PREFERRED EMBODIMENT

As used herein, an element or step recited in the singular and preceded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The present invention contemplates, in one aspect, a simultaneous recording and viewing of a recording which recording is saved so that, when finished, it can be posted to a network, such as a social media or to a website on the internet.

Preferably to the drawing and in accordance herewith the present system or apparatus disposed therein includes a matte surface 310 such as an enlarged pad having a marker 312. The pad is used to determine the position and size of a holographic image within the field of view of a camera of a mobile device or camera 20. The pad need not have codes printed or used thereon, but instead is used for recording of the enhanced reality message.

The pad 310, when acquired may include for downloading to a mobile audio-visual communication device, (e.g. an IPHONE, IPAD, or computer, laptop computer) the software required to create enhanced reality images from the hologram library. Otherwise, the requested software is obtained by downloading a web-based app directly to the mobile devices.

Regardless of how the app is obtained, it is used to access a library of holographic images. Once the matte surface is deployed and a selected hologram H is projected thereon, the camera 20 within the mobile device or webcam is used to record a scene. The recording is done within any desired selected environment. Regardless of the environment, the background is essentially unchanging.

A person 28 may inject himself or herself into the recording by positioning himself or herself with the field of view of the camera. During recording, an external video or forward facing camera of the mobile device enables the user or person 28 to see himself or herself as the enhanced reality message is being created, to allow the person 28 to appropriately position himself or herself within the environment.

Optionally, a positioning guide or other indicator may be placed on a floor 16 where pad is located to provide a guide for placement of the person 28 making the recording.

As noted above, a holographic scene or image, or hologram, itself, is accessed via a web-based downloadable app onto a suitable device, e.g. mobile device. The hologram, is stored in a library of holograms.

The user or person accesses the library and downloads and projects the desired hologram or holographic image onto the marker 312 provided on the surface 310. The library of holographic image are pre-calibrated to the size of the marker such that, any selected one is displayed on the mat as “life-sized”.

In any event, after the recording is finished it may be uploaded to social media sites or sent by e-mail such as FACEBOOK or YouTuBE, either by downloading the recordings onto a computer and uploading it to these sites via the internet 50 or directly from the app.

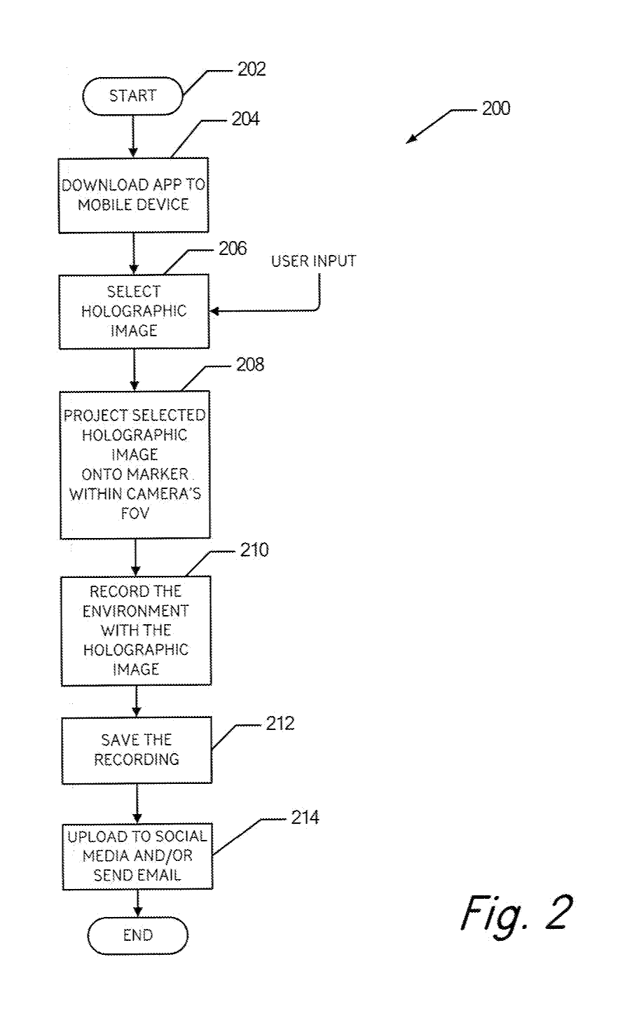

FIG. 2 is a flowchart 200 showing the method hereof and which starts at entry point 202. The user 28 downloads the app for selecting the hologram at 204. The entry point starts where the pad 310 is placed in an environment. The mobile device is then used to access the library and select the desired hologram, at 206. The hologram H is then projected at 208 onto the marker 312 using either the device's camera or a web-cam. Thereafter the person 28 makes the recording at 210.

As noted above, the hologram is pre-calibrated within the library to create a “life sized” image in relation to the size of the marker 312.

These may include images of humans, animated persons, etc. clips of old movie films, clips of sports or political scenes, clips of TV shows, etc. At step 208, the holographic image that is selected (e.g., a still image from the beginning of the holographic image in some embodiments) is superimposed onto matte.

Necessarily, the marker has to be right sized so that the image is pre-calibrated directly relative to the size of the marker.

As shown, the person or user 28 may inject himself or herself into the field of view of the camera 20. On command the recording is produced in which the changing portion of the field of view of camera 20 is captured. Simultaneously an audio may be created via the microphone of the camera 20.

The recording may be previewed in real time on a video monitor or TV or the like.

In any event, the recording is performed at step 212. At step 214, the recording is shared via e-mail or social media by uploading the recording directly from the app to the social media service such as FACEBOOK, YOUTUBE, and/or TWITTER, by way of example.

The social media website, preferably, is a website or e-mail selected by either the user or the sharer. The particular social media is not critical hereto. It is only the ability to share the recording via a social network or by e-mail that is important.

It will thus be appreciated that method and apparatus embodiments disclosed herein provide enhanced messages that provide a substantial visual impact on recipients of such messages. While the invention has been described in terms of various specific embodiments, those skilled in the art will recognize that the invention can be practiced with modification within the spirit and scope of the claims.

What is claimed is:

1. An enhanced messaging system comprising:
a) a mobile device including:
(i) a camera configured to generate a live video signal and to record the same video signal to create a recording;
(ii) means for accessing a downloadable holographic image from a web-based library software;
b) a matte surface defining a marker;
c) means for storing the recording simultaneously with the recording thereof;
d) means for directly uploading the recorded image to a social media, and;
e) wherein the holographic image is pre-calibrated to project a life size image in relation to the size of the marker.

2. The system of claim 1 wherein the means for accessing is a web-based downloadable software application accessible by the mobile device.

3. A method for delivering an enhanced reality message, said method comprising:
a) providing a mobile electronic device, which includes a video camera;
b) downloading a web-based software application for accessing a library of holographic images;
c) providing a marker for displaying a holographic image;
d) selecting a holographic image from the library and projecting it onto the marker;
e) recording the holographic image with the camera;
f) recording the enhanced reality multimedia stream; and
g) sharing the enhanced reality recording via a social media or e-mail, and wherein the holographic images are pre-calibrated relative to the size of the marker to create a life size image thereof in relation to the marker size.

4. The method of claim 3 where in the marker is a matte surface held in view of a camera of the mobile device.
